(19) United States
(12) Patent Application Publication
(10) Pub. No.: US 2010/0059905 A1
(43) Pub. Date: Mar. 11, 2010

(54) Magnetic rubber composition and method for forming molded body from the magnetic rubber composition

(76) Inventor: Tadashi Kasamoto, Okayama (JP)

Correspondence Address: WENDEROTH, LIND & PONACK, L.L.P., 1030 15th Street, N.W.,, Suite 400 East, Washington, DC, 20005-1503, US

(21) Appl. No.: 12/591,300

(22) Filed: Nov. 16, 2009

Related U.S. Application Data
(63) Continuation of application No. 12/222,566, filed on Aug. 12, 2008.
Application No. 12/222,566 is a continuation of application No. 11/355,981, filed on Feb. 17, 2006, now abandoned.

(30) Foreign Application Priority Data
Feb. 21, 2005 (JP) 2005-044283

(51) Int. Cl. H01F 1/26; B29C 35/08

(52) U.S. Cl. 264/429; 252/62.54

(57) ABSTRACT

The invention provides a magnetic rubber composition prepared by kneading an anisotropic magnetic powder, alkoxysilane represented by the formula below, and a rubber binder:

RₐSiX₄₋ₐ

where, in the formula, R is an alkyl group represented by CₙH₂ₙ₊₁, X represents a hydrolysable group such as a methoxy group and an ethoxy group, and a represents an integer of 0 to 3.

### BACKGROUND OF THE INVENTION

1. Field of the Invention

The invention relates to a magnetic rubber composition containing an anisotropic magnetic powder and having good magnetic characteristics, and a method for forming a molded body from the magnetic rubber composition.

2. Description of the Related Art

In a conventional rubber composition, magnetic powders such as powders of rare earth elements or ferrite are added to a rubber material for endowing it with magnetic characteristics. However, while a high magnetic force is expected by using a rare earth magnetic powder, the manufacturing cost is expensive as compared with a material using a ferrite magnetic powder. Accordingly, the ferrite magnetic powder is usually used for the magnetic rubber composition. The ferrite magnetic powder includes powders of a barium-based ferrite and strontium-based ferrite, and the latter has more excellent magnetic power (for example, Japanese Patent Application Laid-Open (JP-A) No. 2003-183518).

A magnetic rubber composition exhibiting excellent magnetic characteristics can be obtained by filling a rubber binder with a high concentration of the magnetic powder. However, since the viscosity of the magnetic rubber composition increases when the proportion of blending of the magnetic power with the rubber binder is too high, processing works such as kneading, extrusion and molding become difficult. The viscosity of the magnetic rubber composition is increased when a magnetic powder with a pressed density of 3.2 g/cm³ or less is used, and processing works such as kneading, extrusion and molding also become difficult.

Accordingly, it may be expected to improve processability as well as processing works such as kneading, extrusion and molding of the magnetic rubber composition, by controlling the proportion of blending of the magnetic powder in the rubber binder and by using the magnetic powder having a pressed density of 3.2 g/cm³ or more. However, it was not sufficient for providing a rubber composition being excellent in processability and exhibiting excellent magnetic characteristics merely to use a magnetic powder with a pressed density of 3.2 g/cm³ or more and to control the proportion of blending of the magnetic powder with the rubber binder.

When a method of applying a mechanical pressure in a rubber kneading process is employed as a molding and processing method for obtaining a molded body from the magnetic rubber composition, the magnetic powder is not so sufficiently orientated in the molded body obtained by the molding method above, and good magnetic characteristics cannot be obtained.

It has been a problem in conventional magnetic rubber compositions and in the method for obtaining a molded body from the magnetic rubber composition that processability is decreased when an improvement of magnetic characteristics is desired or, on the contrary, sufficient magnetic characteristics cannot be obtained when an improvement of processability is desired. Accordingly, there is more room for proposing further improvements with respect to the method for obtaining a magnetic rubber composition that satisfies both excellent processability and excellent magnetic characteristics, and the method for obtaining a molded body from the magnetic rubber composition.

### SUMMARY OF THE INVENTION

Accordingly, it is an object of the present invention to provide a. magnetic rubber composition being excellent in processability and having excellent magnetic characteristics and a method for molding a molded body from the magnetic rubber composition.

The invention for solving the problem provides a magnetic rubber composition prepared by kneading an anisotropic magnetic powder, alkoxysilane represented by the formula below, and a rubber binder:

RₐSiX₄₋ₐ

where, in the formula, R is an alkyl group represented by CₙH₂ₙ₊₁, X represents a hydrolysable group such as a methoxy group and an ethoxy group, and a represents an integer of 0 to 3.

The magnetic rubber composition of the present invention is excellent in processability and has a good orientation ability to permit the composition to exhibit good magnetic characteristics.

Alkoxysilane in the magnetic rubber composition according to the invention is a compound represented by RₐSiX₄₋ₐ as described above, where R is an alkyl group represented by CₙH₂ₙ₊₁, X represents a hydrolysable group such as a methoxy group and an ethoxy group, and a represents an integer of 0 to 3.

Examples of alkoxysilane include tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, hexyltrimeyhoxysilane and decyltrimethoxysilane.

Any anisotropic magnetic powders conventionally used in the art may be used as the anisotropic magnetic powder in the magnetic rubber composition according to the invention.

For example, strontium ferrite, neodymium-iron-boron base magnetic power, samarium-cobalt base magnetic powder and samarium-iron-nitrogen base magnetic powder may be used as the anisotropic magnetic powder. At least one of them may be used, i.e., at least one of them may be used alone, or a plurality of them may be used in combination.

When the strontium ferrite is used as the anisotropic magnetic powder, the magnetic rubber composition being excellent in processability, having good orientation ability and exhibiting excellent magnetic characteristics may be provided with a relatively low cost.

Desirably, the pressed density of the anisotropic magnetic powder in the magnetic rubber composition of the invention is 3.2 g/cm³ or more, preferably 3.3 g/cm³ or more. Processability may be deteriorated by using the magnetic powder with a pressed density of 3.2 g/cm³ or less. The magnetic rubber composition being excellent in processability and having excellent magnetic characteristics may be stably provided by using the magnetic powder with a pressed density of 3.2 g/cm³ or more, preferably 3.3 g/cm³ or more.

Rubber materials having good oil resistance may be used as the binder rubber in the magnetic rubber composition according to the invention. For example, nitrile-butadiene rubber, hydrogenated Acrylonitrile-butadiene rubber, acrylic rubber, ethylene-acrylate rubber and fluoro rubber may be used. At least one of them may be used, i.e., at least one of them may be used alone, or two or more of them may be used together by appropriately blending.

Compounding agents usually used in conventional rubber compositions may be appropriately blended in the magnetic rubber composition other than the essential ingredients described above. For example, carbon black or white fillers such as silica and clay, plasticizers, slip agents, processing agents, anti-aging agents, zinc oxide, cross-linking agents and cross-linking accelerators may be appropriately used as the compounding agent.

The anisotropic magnetic powder to be blended is desirably added so that the proportion is 74 to 94% by weight relative to the total weight of the rubber composition according to the invention. Practical magnetic characteristics cannot be obtained when the proportion of addition of the magnetic powder in the total amount of the rubber composition, or the filling rate; is less than 74% by weight, while magnetic characteristics are decreased due to interaction between the magnetic powders and processability is remarkably decreased when the filling rate exceeds 94% by weight.

The rubber binder to be blended is desirably added in a proportion of 5 to 22% by weight relative to the total amount of the magnetic rubber composition. Processability decreases when the proportion of addition relative to the total amount of the magnetic rubber composition is less than 5% by weight, while practical magnetic characteristics cannot be obtained when the proportion exceeds 22% by weight.

The amount of addition of alkoxysilane described above is desirably 0.05 to 20 parts by weight relative to 100 parts by weight of rubber binder. An improvement of the orientation ability accompanying an improvement effect of magnetic characteristics cannot be attained when the proportion is less than 0.05 parts by weight, while sulfurization rate is slowed to remarkably reduce processability when the proportion exceeds 20 parts by weight.

The magnetic rubber composition of the invention can be obtained by appropriately blending the essential ingredients with the compounding agents usually used for the conventional rubber composition, and by kneading with a conventional mixing machine, or an open roll, a kneader, a Banbury mixer or a double screw extruder.

In order to solve the forementioned problems, a method of forming a molded body from the magnetic rubber composition proposed by the present invention includes the step of molding one of the magnetic rubber compositions of the invention with sulfurization in a mold in an applied magnetic field.

The magnetic rubber composition of the invention is excellent in processability and exhibits excellent magnetic characteristics as hitherto described. The degree of orientation of the anisotropic magnetic powder may be enhanced by molding with sulfurization in a mold by applying a magnetic field in the sulfurization molding process.

A method proposed in JP-A No. 2003-25363 can be used, for example, as a method for molding with sulfurization of the magnetic rubber composition in a mold in an applied magnetic field.

For example, in the method of forming a molded body from the magnetic rubber composition proposed by the present invention, a mold known in the art is surrounded by an electromagnetic coil during molding with sulfurization with heating while a given pressure is applied to the magnetic rubber composition. A magnetic field is generated by applying a given intensity of voltage to the electromagnetic coil at the time of sulfurization molding of the rubber composition according to the invention using the mold, and the rubber composition is molded with sulfurization by applying a magnetic field.

According to the molding method of the invention, the rubber composition of the invention being excellent in processability and exhibiting excellent magnetic characteristics is molded with sulfurization in the mold in an applied magnetic field, and the anisotropic magnetic powder in the molded body obtained is sufficiently oriented to enable the molded body having good magnetic characteristics to be obtained.

As described in detail above, the invention provides a magnetic rubber composition being excellent in processability and having good magnetic characteristics, and a method for forming a molded body from the magnetic rubber composition.

### DESCRIPTION OF THE PREFERRED EMBODIMENTS

The best mode for obtaining the rubber composition of the invention, and for forming a molded body from the magnetic rubber composition will be described below, wherein an anisotropic magnetic powder, an alkoxysilane base monomer and a rubber binder are kneaded to obtain the magnetic rubber composition, and the composition is kneaded to obtain the molded body.

The magnetic rubber compositions in the below described Examples 1 to 4 and comparative magnetic rubber compositions in the below described Comparative Examples 1 to 3 were evaluated. Blending, manufacturing methods and evaluation methods in Examples 1 to 4 and Comparative Examples 1 to 3 are shown below.

Hydrogenated Acrylonitrile-butadiene rubber (HNBR polymer) was used as the rubber binder. A strontium ferrite magnetic powder and other compounding agents were blended relative to 100 parts by weight of the rubber binder so as to be the filling rates shown in Table 1, and the mixture was kneaded in an open roll to obtain the magnetic rubber composition.

In Example 1, 6 parts by weight of alkoxysilane was blended relative to 100 parts by weight of the hydrogenated Acrylonitrile-butadiene rubber polymer. On the other hand, Liquid NBR, bis(2-ethylhexyl)phthalate (hereinafter referred to DOP), and polybutadiene were blended in Comparative Example 1, Comparative Example 2 and Comparative Example 3, respectively, in place of alkoxysilane blended in Example 1. The other blending compositions and amounts of blending are the same in Example 1 and Comparative Examples 1 to 3.

In Examples 2 to 4, the proportions of blending of alkoxysilane were changed as compared with Example 1. The proportions of blending of alkoxysilane were reduced in Examples 2 and 3 as compared with Example 1, and DOP was added. The proportion of blending of alkoxysilane was increased in Example 4 as compared with Example 1.

The pressed density of the strontium ferrite powder was 3.3 g/cm³ in all Examples and Comparative Examples.

A magnetic field with an intensity of 20 kOe was applied in the direction of thickness of the base rubber while the magnetic rubber composition is molded with sulfurization in a sample mold, that is, from the beginning to the end of the sulfurization. The sulfurization temperature was 190° C., and the sulfurization time was 90 seconds. Thus, columnar molded bodies with a diameter of 18 mm and a thickness of 6 mm were obtained as Examples 1 to 4 and Comparative Examples 1 to 3.

The magnetic characteristics Br(T), such as residual induction Br(T), for example, of the molded body, as test specimen, were measured with a BH curve tracer (trade name, manufactured by Metron, Inc.). The lowest viscosity at 180° C. was measured with Curelastometer type V (trade name, manufactured by Orientec Co., Ltd.) for assessing processability. The results are shown in Table 1.

TABLE 1

| | | | | | Compara. | Compara. | Compara. |
|---|---|---|---|---|---|---|---|
| | Example 1 | Example 2 | Example 3 | Example 4 | Example 1 | Example 2 | Example 3 |
| Hydrogenated NBR | 100 | 100 | 100 | 100 | 100 | 100 | 100 |
| Polymer | | | | | | | |
| Strontium Ferrite | 1100 | 1100 | 1100 | 1100 | 1100 | 1100 | 1100 |
| Alkoxysilane | 6 | 3 | 1 | 10 | — | — | — |
| Liquid NBR | — | — | — | — | 6 | — | — |
| DOP | — | 3 | 5 | — | — | 6 | — |
| Polybutadiene | — | — | — | — | — | — | 6 |
| Stearic Acid | 1 | 1 | 1 | 1 | 1 | 1 | 1 |
| Carnauba Wax | 2 | 2 | 2 | 2 | 2 | 2 | 2 |
| Paraffin Wax | 1 | 1 | 1 | 1 | 1 | 1 | 1 |
| Anti-Aging Agent | 1.5 | 1.5 | 1.5 | 1.5 | 1.5 | 1.5 | 1.5 |
| Active Zinc Oxide | 4 | 4 | 4 | 4 | 4 | 4 | 4 |
| Sulfur | 0.5 | 0.5 | 0.5 | 0.5 | 0.5 | 0.5 | 0.5 |
| Vulcanization Accelerator | 4.5 | 4.5 | 4.5 | 4.5 | 4.5 | 4.5 | 4.5 |
| Residual Induction Br (T) | 0.278 | 0.274 | 0.272 | 0.283 | 0.249 | 0.245 | 0.247 |
| 180° C. lowest viscosity | 4.4 | 5.0 | 5.1 | 4.0 | 6.8 | 6.6 | 9.5 |
| (kgf · cm) | | | | | | | |

In Table 1
Hydrogenated NBR Polymer: Trade Name, Zetpol 1020; Manufactured by Zeon Corporation
Strontium Ferrite: Trade Name, FM-201; Manufactured by Toda Kogyo Corp.
Alkoxysilane: Trade Name, KBM3103C; Manufactured by Shin-Etsu Chemical Co., Ltd.
Liquid NBR: Trade Name, Nipol 1312; Manufactured by Zeon Corporation
Polybutadiene: Trade Name, RB810; Manufactured by JSR Corporation

While the magnetic rubber compositions in Comparative Examples 1 to 3 are molded with sulfurization in a mold in an applied magnetic field as the magnetic rubber compositions in Examples 1 to 4, the latter compositions are excellent in processability with a low lowest viscosity and are excellent in magnetic characteristics Br(T) (residual induction Br(T)) as compared with the former compositions. It was confirmed that the magnetic rubber compositions in Examples 1 to 4 that fall within the range of blending of the components according to the invention are excellent in processability as well as in magnetic characteristics Br(T) (residual induction Br(T)).

In Examples 1 to 4 in which the proportion of blending of alkoxysilane was changed, the magnetic rubber composition is also excellent in processability and magnetic characteristics Br(T) (residual induction Br(T)) within the range of blending of the components according to the invention.

Although preferable examples of the present invention are described above, the present invention is not limited to the before described examples, and the present invention may be modified to various embodiments and examples within the technological scope defined by the accompanying claims and equivalents thereof.

What is claimed is:

1. A magnetic rubber composition prepared by kneading an anisotropic magnetic powder, alkoxysilane represented by the formula below, and a rubber binder:
RₐSiX₄₋ₐ
where, in the formula, R is an alkyl group represented by CₙH₂ₙ₊₁, X represents a hydrolysable group such as a methoxy group and an ethoxy group, and a represents an integer of 0 to 3.

2. The magnetic rubber composition according to claim 1, wherein the anisotropic magnetic powder is a strontium ferrite powder.

3. The magnetic rubber composition according to claim 1, wherein the pressed density of the anisotropic magnetic powder is 3.2 g/cm³ or more.

4. The magnetic rubber composition according to claim 2, wherein the pressed density of the anisotropic magnetic powder is 3.2 g/cm³ or more.

5. A method for forming a molded body from a magnetic rubber composition comprising the step of molding the magnetic rubber composition according to claim 1 with sulfurization in a mold in an applied magnetic field.

6. A method for forming a molded body from a magnetic rubber composition comprising the step of molding the magnetic rubber composition according to claim 2 with sulfurization in a mold in an applied magnetic field.

7. A method for forming a molded body from a magnetic rubber composition comprising the step of molding the magnetic rubber composition according to claim 3 with sulfurization in a mold in an applied magnetic field.

8. A method for forming a molded body from a magnetic rubber composition comprising the step of molding the magnetic rubber composition according to claim 4 with sulfurization in a mold in an applied magnetic field.
